(19) United States
(12) Patent Application Publication
(10) Pub. No.: US 2021/0319113 A1
(43) Pub. Date: Oct. 14, 2021

(54) METHOD FOR GENERATING MALICIOUS SAMPLES AGAINST INDUSTRIAL CONTROL SYSTEM BASED ON ADVERSARIAL LEARNING

(71) Applicant: ZHEJIANG UNIVERSITY, Hangzhou City, Zhejiang Province (CN)

(72) Inventors: Peng CHENG, Hangzhou City, Zhejiang Province (CN); Xiangshan GAO, Hangzhou City, Zhejiang Province (CN); Ruilong DENG, Hangzhou City, Zhejiang Province (CN); Jingpei WANG, Hangzhou City, Zhejiang Province (CN); Jiming CHEN, Hangzhou City, Zhejiang Province (CN); Youxian SUN, Hangzhou City, Zhejiang Province (CN)

(21) Appl. No.: 16/982,056

(22) PCT Filed: Aug. 18, 2019
(86) PCT No.: PCT/CN2019/101247

§ 371 Date: Sep. 18, 2020

(30) Foreign Application Priority Data
Jan. 7, 2019 (CN) 201910011642.4

(51) Int. Cl. G06F 21/57; G05B 13/02; G06N 3/04; G06N 3/08; G06F 21/56

(52) U.S. Cl. CPC G06F 21/577; G05B 13/027; G06F 2221/034; G06N 3/08; G06F 21/566; G06N 3/0472

(57) ABSTRACT

A method for generating malicious samples against an industrial control system based on adversarial learning is provided. With the method, the adversarial samples for the industrial control intrusion detection system based on the machine learning method is calculated using the adversarial learning technology and the optimization algorithm. The attack sample that can be detected by the intrusion detection system before generates a corresponding new adversarial sample after being processed with this method. This adversarial sample still maintain the attack effect after evading the original intrusion detector (being identified as normal). The present disclosure effectively ensures the security of the industrial control system and prevents accidents by actively generating malicious samples against the industrial control system.

### TECHNICAL FIELD

The present disclosure belongs to the field of industrial control system security, and relates to a method for generating malicious samples against an industrial control system based on adversarial learning.

### BACKGROUND

Frequent occurring of industrial control system security incidents have attracted great attention from countries all over the world. In order to actively respond to the industrial control security issues, various solutions, such as the formulation of specification standards and the deployment of intrusion detection have been proposed. In industrial control systems, network-based intrusion detectors are very typical and common. The security of the industrial control system can be greatly improved by deploying of a network anomaly detection device between the application network (IT) and the control network (OT). At present, the anomaly detection algorithms based on machine learning has a distinguished performance in abnormal network traffic identification. These machine learning techniques can find out the inherent behavior patterns from a large amount of historical data in the industrial control system to build the anomaly detection system.

On the other hand, the intrusion detectors of current industrial control systems based on machine learning are vulnerable in some aspects. In practical application, the machine learning model is easily manipulated by the adversarial samples that are intentionally generated by the attacker. The attacker can control the algorithm model to produce a result that is totally different from the normal output by making a minor modification to the tested sample. The sample that causes the model to produce incorrect predictions is referred to as an adversarial sample. A study in which the machine learning is designed to actively generate an adversarial attack is referred to as adversarial machine learning study. This adversarial attack brings a potential security threat to the system based on machine learning, in particular the system with high security requirements, for example, the industrial control.

For the intrusion detection system of the industrial control system based on machine learning, it cannot identify the malicious traffic that could have been identified if subjected to an adversarial attack deliberately generated by the attacker. This will bring a great security thread to the industrial control system. The existing study on industrial control security intrusion detection lacks the study on the adversarial learning portion, while it is meaningful to simulate the attacker to actively generate the adversarial samples for the industrial control machine learning detection algorithm. Therefore, it is necessary for the industrial control intrusion detection system to conduct a study on adversarial machine learning, and actively generate adversarial samples that can evade the detector to complete stealthy attacks, so as to ensure the security of the system and take the precautions.

### SUMMARY

In view of the drawbacks and deficiencies in the security of an industrial control system, the present disclosure provides a method for generating malicious samples against an industrial control system based on adversarial learning.

A method for generating malicious samples against an industrial control system based on adversarial learning includes following steps.

(1) An adversarial sample generator sniffs industrial control system communication data to obtain communication data having a same distribution with the training data used by an industrial control intrusion detection system, and the communication data are tagged with category labels. The category includes abnormality and normality, and the abnormal communication data is taken as an original attack sample. The industrial control intrusion detection system is an existing industrial control intrusion detection system based on machine learning.
(2) Protocol parsing is performed on industrial control system communication data and effective features of the industrial control system communication data are identified and extracted. The effective features includes a source IP address (SIP), a source port number (SP), destination IP address (DIP), a destination port number (DP), packet time delta, packet transmission time, and a packet function code of the communication data.
(3) A machine learning classifier is established based on the effective features extracted in step (2), and the machine learning classifier is trained using the industrial control system communication data tagged with labels to obtain a trained classifier for distinguishing normal communication data and abnormal communication data.
(4) An adversarial learning problem of the industrial control intrusion detection system is transformed into an optimization problem, and the optimization problem is solved to obtain a final adversarial sample. The optimization problem is:

x*=arg min g(x), and

s.t.d(x*,x⁰)<dₘₐₓ,

where g(x) represents a possibility that the adversarial sample x* is determined as an abnormal sample and is calculated by a classifier; d(x*, x⁰) represents a distance between the adversarial sample and the original attack sample, and dₘₐₓ represents a maximum Euclidean distance allowed by the industrial control system. It is indicated that the adversarial sample has no malicious effect if the distance is exceeded.
(5) The adversarial sample generated in step (4) is tested in an actual industrial control system. If the adversarial sample successfully evades the industrial control intrusion detection system and retains an attack effect, the adversarial sample is taken as an effective adversarial sample. If the adversarial sample fails to evade the industrial control intrusion detection system or retain an attack effect, the adversarial sample is discarded.

Further, in the step (1), the adversarial sample generator is a black box attacker and is incapable of directly acquiring same data as the industrial control intrusion detection system (detection party).

Further, in the step (2), different effective features of the effective features are extracted based on different communication protocols of the industrial control system, the different communication protocols of the industrial control system include Modbus, PROFIBUS, DNP3, BACnet, and Siemens S7, and each of the different communication protocols has a corresponding format and an application scenario, and the different communication protocols are parsed based on specific scenarios to obtain an effective feature set.

Further, in the step (3), a classifier used by the adversarial sample generator for training is different from a classifier used by the industrial control intrusion detection system, i.e., detection party, and a classifier generated by the adversarial sample generator is referred to as a local substitute model of the adversarial learning, and a principle of the local substitute model is a transferability of an adversarial learning attack.

Further, in the step (4), solutions to the optimization problem include gradient descent method, Newton method, and constrained optimization BY linear approximations (COBYLA) method.

Further, in step (4), the distance is expressed as one-norm distance, two-norm distance, or an infinite-norm distance.

Further, in step (4), the machine learning classifier uses a neural network, and a probability of the neural network is calculated by:

$$p ( y = j \vert {x}^{( i )} ; θ ) = \frac{{e}^{{θ}_{j}^{{T}_{x} ( i )}}}{{\sum }_{l = 1}^{k} {e}^{{θ}_{l}^{{T}_{x} ( i )}}} ,$$

where p represents a predicted probability, x⁽ⁱ⁾ represents an i^{th} feature of a sample x, y represents a label j corresponding to the sample x, θ represents a parameter of the neural network, θⱼ represents a parameter of the neural network corresponding to the label j, and k is a total number of labels.

The adversarial learning problem of the industrial control intrusion detection system is transformed into the following optimization problem:

x*=−arg min [p(x)=0], and

s.t.d(x*,x⁰)<dₘₐₓ.

Further, in the step (4), for a specific control scenario, a special constraint for a variable is added in the optimization problem, and when applying the method, the generator is configured to add different constraints for variables in specific dimensions based on a specific scenario when designing the optimization problem, in such a manner that the generated adversarial sample is capable of effectively completing a malicious attack.

The method for generating the malicious samples against the industrial control system based on the adversarial learning improves the security of the industrial control system. The study on adversarial learning are expanded from the field of machine vision and speech to the field of industrial control. The security performance of the industrial control intrusion detection system based on machine learning is improved, and attacks from malicious samples are prevented.

### BRIEF DESCRIPTION OF DRAWINGS

FIG. 1 is a block diagram of a method according to the present disclosure; and

FIG. 2 is a simulation result of the method according to the present disclosure.

### DESCRIPTION OF EMBODIMENTS

The present disclosure will be further described in detail below with reference to the drawings and specific embodiments.

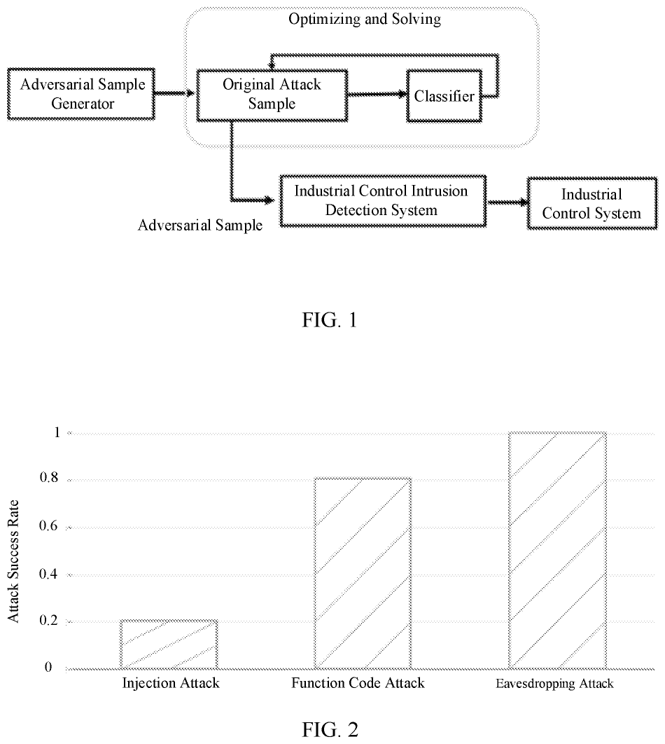

As shown in FIG. 1, a method for generating malicious samples against an industrial control system based on adversarial learning provided by the present disclosure includes the following steps.

(1) An adversarial sample generator sniffs industrial control system communication data to obtain communication data having a same distribution as training data used by an industrial control intrusion detection system, and the communication data are tagged with category labels. The category includes abnormality and normality, and the abnormal communication data is taken as an original attack sample. The industrial control intrusion detection system is an existing industrial control intrusion detection system based on machine learning.

The adversarial sample generator is a black box attacker and is incapable of directly acquiring same data as the industrial control intrusion detection system (detection party).

(2) Protocol parsing is performed on industrial control system communication data and effective features of the industrial control system communication data are identified and extracted. The effective features includes a source IP address (SIP), a source port number (SP), a destination IP address (DIP), a destination port number (DP), packet time delta, packet transmission time, and a packet function code of communication data.

Different effective features of the effective features are extracted based on different communication protocols for the industrial control system, commonly used communication protocols of the industrial control system include Modbus, PROFIBUS, DNP3, BACnet, and Siemens S7, and each communication protocols has a corresponding format and an application scenario, and the communication protocols are analyzed based on specific scenarios to obtain an effective feature set.

(3) A machine learning classifier is established based on the effective features extracted in step (2), and the machine learning classifier is trained using the industrial control system communication data tagged with labels to obtain a trained classifier for distinguishing between normal communication data and abnormal communication data.

A classifier used by the adversarial sample generator for training is different from a classified used by the industrial control intrusion detection system, i.e., detection party, and a classifier generated by the adversarial sample generator is referred to as a local substitute model of the adversarial learning, a principle of the local substitute model is a transferability of an adversarial learning attack.

(4) An adversarial learning problem of the industrial control intrusion detection system is transformed into an optimization problem, and the optimization problem is solved to obtain a final adversarial sample. The optimization problem is:

x*=arg min g(x), and

s.t.d(x*,x⁰)<dₘₐₓ,

where g(x) represents a possibility that the adversarial sample x* is determined as an abnormal sample and is calculated by a classifier; d(x*, x⁰) represents a distance between the adversarial sample and the original attack sample, and dₘₐₓ represents a maximum Euclidean distance allowed by the industrial control system. It is indicated that the adversarial sample has no malicious effect if the distance is exceeded. A solutions to the optimization problem includes gradient descent method, Newton method, constrained optimization BY linear approximations (COBYLA) method, etc. Expressions of the distance include a one-norm distance, a two-norm distance, and an infinite-norm distance.

For a specific control scenario, a special constraint for a variable is added in the optimization problem, and when applying the method, the generator is configured to add different constraints for variables in specific dimensions based on a specific scenario when designing the optimization problem, in such a manner that the generated adversarial sample is capable of effectively completing a malicious attack.

The machine learning classifier can use a neural network, and when the neural network is used, a probability can be calculated as follows:

$$p ( y = j \vert {x}^{( i )} ; θ ) = \frac{{e}^{{θ}_{j}^{{T}_{x} ( i )}}}{{\sum }_{l = 1}^{k} {e}^{{θ}_{l}^{{T}_{x} ( i )}}} ,$$

where p represents a predicted probability, x⁽ⁱ⁾ represents an i^{th} feature of a sample x, y represents a label j corresponding to the sample x, θ represents a parameter of the neural network, θⱼ represents a parameter of the neural network corresponding to the label j, and k is a total number of labels. The adversarial learning problem of the industrial control intrusion detection system is transformed into the following optimization problem:

x*=−arg min[p(x)=0], and

s.t.d(x*,x⁰)<dₘₐₓ.

(5) The adversarial sample generated in step (4) is tested in an actual industrial control system. If the adversarial sample successfully evades the industrial control intrusion detection system and retains an attack effect, the adversarial sample is taken as an effective adversarial sample. If the adversarial sample fails to evade the industrial control intrusion detection system or retain an attack effect, the adversarial sample is discarded.

Taking a specific application scenario as an example, the process of generating the adversarial sample for the industrial control intrusion detection system includes following steps.

1. The communication data used by the existing industrial control system intrusion detector based on machine learning is sniffed, and initial attack samples include injection attack, function code attack, and eavesdropping attack.

2. Analyzing of the Protocols such as Siemens S7comm protocol is performed to obtain the features such as source IP, destination IP, the port number, function code, function sub-code, and packet interval time.

3. An alternative classifier is generated locally, for example, by using a multilayer perceptron to generate a basic neural network algorithm.

4. It is designated to solve the optimization problem according to the neural network, and the constraints for the specific application scenario, such as the fixed selected value of the function code, are added, and other network features are discrete positive integer values, etc.

5. The adversarial sample is calculated with the COBYLA method and its adversarial effect is tested on the industrial control system security test platform, the attack success rate of the three initial attack samples are shown in FIG. 2. It can be seen from FIG. 2 that the method according to the present disclosure has an attack success rate of 100% for the eavesdropping attack and an attack success rate of 80% for the function code attack, and although it is difficult for the injection attack to complete the transformation between the original attack sample and the adversarial sample, because of the complexity of the actual attack, its attack success rate can still reach 20%.

The above embodiments are used to explain the present disclosure, but not limit the present disclosure, any modifications and changes made to the present disclosure within the spirit of the present disclosure and the protection scope of the claims fall within the protection scope of the present disclosure.

What is claimed is:

1. A method for generating malicious samples against an industrial control system based on adversarial learning, comprising:
step 1 of sniffing, by an adversarial sample generator, industrial control system communication data to obtain communication data having a same distribution as training data used by an industrial control intrusion detection system, tagging the communication data with category labels, and taking an abnormal communication datum of the tagged communication data as an original attack sample;
step 2 of performing protocol parsing on the industrial control system communication data and identifying and extracting effective features from the industrial control system communication data, the effective features comprising a source IP address (SIP), a source port number (SP), a destination IP address (DIP), a destination port number (DP), packet time delta, packet transmission time, and a packet function code of communication data;
step 3 of establishing a machine learning classifier based on the effective features extracted in the step 2, and training the machine learning classifier using the industrial control system communication data tagged with labels to obtain a trained classifier for distinguishing between normal communication data and abnormal communication data;
step 4 of transforming an adversarial learning problem of the industrial control intrusion detection system into an optimization problem by using the classifier established in the step 3, and solving the optimization problem to obtain a final adversarial sample, the optimization problem being:
x*=arg min g(x), and
s.t.d(x*,x⁰)<dₘₐₓ,
where g(x) represents a possibility that the adversarial sample x* is determined as an abnormal sample and is calculated by a classifier; d(x*, x⁰) represents a distance between the adversarial sample and the original attack sample, and dₘₐₓ represents a maximum Euclidean distance allowed by the industrial control system, and it is indicated that the adversarial sample has no malicious effect if the distance is exceeded; and
step 5 of testing the adversarial sample generated in the step 4 in an actual industrial control system, wherein if the adversarial sample successfully evades the industrial control intrusion detection system and retains an attack effect, the adversarial sample is taken as an effective adversarial sample; and if the adversarial sample fails to evade the industrial control intrusion detection system or retain an attack effect, the adversarial sample is discarded.

2. The method for generating the malicious samples against the industrial control system based on the adversarial learning according to claim 1, wherein in the step 1, the adversarial sample generator is a black box attacker and is incapable of directly acquiring same data as the industrial control intrusion detection system (detection party).

3. The method for generating the malicious samples against the industrial control system based on the adversarial learning according to claim 1, wherein in the step 2, different effective features of the effective features are extracted based on different communication protocols of the industrial control system, the different communication protocols of the industrial control system include Modbus, PROFIBUS, DNP3, BACnet, and Siemens S7, and each of the different communication protocols has a corresponding format and an application scenario, and the different communication protocols are parsed based on specific scenarios to obtain an effective feature set.

4. The method for generating the malicious samples against the industrial control system based on the adversarial learning according to claim 1, wherein in the step 3, a classifier used by the adversarial sample generator for training is different from a classifier used by the industrial control intrusion detection system, and a classifier generated by the adversarial sample generator is referred to as a local substitute model of the adversarial learning, and a principle of the local substitute model is a transferability of an adversarial learning attack.

5. The method for generating the malicious samples against the industrial control system based on the adversarial learning according to claim 1, wherein in the step 4, solutions to the optimization problem comprise gradient descent method, Newton method, and constrained optimization BY linear approximations (COBYLA) method.

6. The method for generating the malicious samples against the industrial control system based on the adversarial learning according to claim 1, wherein in the step 4, the distance is expressed as a one-norm distance, a two-norm distance, and an infinite-norm distance.

7. The method for generating the malicious samples against the industrial control system based on the adversarial learning according to claim 1, wherein in the step 4, the machine learning classifier uses a neural network, and a probability of the neural network is calculated by:
$$p ( y = j \vert {x}^{( i )} ; θ ) = \frac{{e}^{{θ}_{j}^{{T}_{x} ( i )}}}{{\sum }_{l = 1}^{k} {e}^{{θ}_{l}^{{T}_{x} ( i )}}} ,$$
where p represents a predicted probability, x⁽ⁱ⁾ represents an i^{th} feature of a sample x, y represents a label j corresponding to the sample x, θ represents a parameter of the neural network, θⱼ represents a parameter of the neural network corresponding to the label j, and k is a total number of labels;
wherein the adversarial learning problem of the industrial control intrusion detection system is transformed into an optimization problem:
x*=−arg min[p(x)=0], and
s.t.d(x*,x⁰)<dₘₐₓ.

8. The method for generating the malicious samples against the industrial control system based on the adversarial learning according to claim 1, wherein in the step 4, for a specific control scenario, a special constraint for a variable is added in the optimization problem, and when applying the method, the generator is configured to add different constraints for variables in specific dimensions based on a specific scenario when designing the optimization problem, in such a manner that the generated adversarial sample is capable of effectively completing a malicious attack.
